(19) United States
(12) Patent Application Publication
(10) Pub. No.: US 2024/0227917 A9
(43) Pub. Date: Jul. 11, 2024

(54) ELECTRIC MOTOR ASSEMBLY

(71) Applicant: JTEKT EUROPE, Irigny (FR)

(72) Inventor: Patrice BROCHOT, Oullins (FR)

(73) Assignee: JTEKT EUROPE, Irigny (FR)

(21) Appl. No.: 18/382,135

(22) Filed: Oct. 20, 2023

(30) Foreign Application Priority Data
Oct. 21, 2022 (FR) 22/10939

(51) Int. Cl. B62D 5/04; H02K 5/16; H02K 21/02

(52) U.S. Cl. CPC B62D 5/0406; H02K 5/161; H02K 21/02

(57) ABSTRACT

A motor assembly including a casing of which at least a part extends along a longitudinal axis of the casing, a stator fixedly mounted in the casing, a rotor movably mounted in rotation in the casing, the rotor including a drive shaft configured to be guided in rotation about an axis of rotation of the drive shaft, a first guide bearing configured to guide in rotation the drive shaft about the axis of rotation of the drive shaft, the motor assembly being characterized in that it includes further a guide bearing support configured to couple with the casing and to support the first guide bearing, the guide bearing support and the casing being further configured such that a coupling of the guide bearing support and of the casing makes it possible to exert an adjustable axial preload on the first guide bearing.

### TECHNICAL FIELD

The invention, which belongs to the field of motors, relates to an electric motor assembly.

### STATE OF THE ART

An assembly of an electric motor known from the state of the art consists in particular of a casing, generally made of aluminum alloy or steel alloy, constituting a shell whose function is to protect at least some of the constituent elements of the motor. An electric motor casing known from the state of the art is substantially cylindrical in shape and extends along a longitudinal axis of the casing. The assembly also consists of a stator mounted fixedly in the casing and generally entirely comprised inside the casing, the stator also being cylindrical in shape and extending along the longitudinal axis of the casing. The assembly also comprises a rotor mounted in rotation inside the casing and comprising a drive shaft capable of being rotatably driven about an axis of rotation generally coincident with the longitudinal axis of the casing. The assembly also comprises at least one guide bearing, generally two guide bearings, configured to rotatably guide the drive shaft of the rotor.

Such a motor assembly generally has assembly clearances and experiences thermal expansion during operation due to the heating of certain elements of the motor during operation. It is necessary to fill assembly gaps and compensate for thermal expansions in order to ensure reliable operation and satisfactory life of the motor. Indeed, such assembly clearances and such thermal expansions can in particular disrupt the rotation of the drive shaft of the motor, cause vibrations, friction, unwanted noise in the motor assembly and overall abnormal wear of at least some of the constituent elements of the motor.

The filling of the assembly clearances and the compensation of thermal expansions are in particular carried out by means of the application of an axial preload on the at least one guide bearing. An axial preload, unlike a radial preload which is exerted in a direction substantially orthogonal to the longitudinal axis of the casing, is exerted in a direction substantially parallel to the longitudinal axis of the casing and therefore parallel to the axis of rotation of the rotor drive shaft. Such axial preload, which can only be exerted on certain types of guide bearings with axial preload, is generally produced by means of at least one elastic element of particular shape and suitably placed against or near the guide bearing.

However, the axial preload exerted on the at least one guide bearing by such an elastic element has the disadvantage of depending on the assembly tolerances, which does not allow the application of an optimal preload on the at least one guide bearing. Furthermore, the presence of such an elastic element, which occupies space inside the casing, increases the total length of the motor assembly, which constitutes a disadvantage in certain environments or for certain applications, in which the space available to position the motor is very limited. Especially since such an electric motor is generally controlled by an electronic control card positioned on a support generally fixed at one end of the casing and which also occupies a significant additional space.

### SUMMARY OF THE INVENTION

The present application, which aims to resolve all or part of the aforementioned drawbacks, relates to a motor assembly comprising:
a casing;
a stator fixedly mounted in the casing;
a rotor movably mounted in rotation in the casing, the rotor comprising a drive shaft which has a first drive shaft end portion and a second drive shaft end portion, the drive shaft being configured to be guided in rotation about an axis of rotation of the drive shaft;
a first guide bearing configured to rotatably guide the drive shaft about the axis of rotation of the drive shaft;
the motor assembly being characterized in that it further comprises a guide bearing support configured to be coupled to the casing and support the first guide bearing, the guide bearing support and the casing being further configured such that a coupling of the guide bearing support and the casing makes it possible to exert an adjustable axial preload on the first guide bearing.

Compared to the motor assemblies of the prior art, the solution of the invention makes it possible to exert an adjustable axial preload on at least one guide bearing. A such adjustable axial preload does not depend on assembly tolerances and does not require the presence of additional elements such as a resilient element inside the motor assembly, thereby providing a more compact motor assembly.

The motor assembly may further have one or more of the following features, taken alone or in combination.

According to an embodiment of the invention, the casing comprises a first coupling part, and the guide bearing support comprises a second coupling part capable of cooperating with the first coupling part.

According to an embodiment of the invention, at least part of the casing extends along a longitudinal axis of the casing between a first casing end portion and a second casing end portion, the first casing end portion comprising the first coupling part.

According to an embodiment of the invention, the part of the casing, which extends along the longitudinal axis of the casing between a first casing end portion and a second casing end portion, surrounds at least some of the constituent elements of the motor assembly, and in particular the stator, the first guide bearing and all or part of the rotor.

According to an embodiment of the invention, the part of the casing, which extends along the longitudinal axis of the casing between a first casing end portion and a second casing end portion, has the shape of a hollow cylinder and comprises an outer surface defining an outer diameter, and an inner surface defining an inner diameter.

According to an embodiment of the invention, the casing is made of metal, and for example of an aluminum alloy.

According to an embodiment of the invention, the casing is made of plastic.

According to an embodiment of the invention, the stator is mounted in the casing so as to be directly placed against a part of the casing, and in particular against the inner surface of the casing.

According to an embodiment of the invention, at least one part of the stator has the shape of a hollow cylinder which extends along a longitudinal axis of the casing substantially parallel to the longitudinal axis of the casing and comprises an outer surface defining an outer diameter and an inner surface defining at least one inner diameter.

According to an embodiment of the invention, the inner diameter of the casing defined by the inner surface of the casing takes several distinct values.

According to an embodiment of the invention, the stator is mounted in the casing such that at least part of the outer surface of the stator is placed against a part of the inner surface of the casing.

According to an embodiment of the invention, the longitudinal axis of the stator is substantially parallel to the longitudinal axis of the casing.

According to an embodiment of the invention, the longitudinal axis of the stator coincides with the longitudinal axis of the casing.

According to an embodiment, the stator is at least partly made of metal. For example, the part of the stator which has the shape of a hollow cylinder is made of steel selected for its magnetic properties and the stator further comprises a copper winding wound about the portion of the stator having the shape of a hollow cylinder.

According to an embodiment of the invention, the axis of rotation of the drive shaft is substantially parallel to the longitudinal axis of the casing.

According to an embodiment of the invention, the axis of rotation of the drive shaft coincides with the longitudinal axis of the casing.

According to an embodiment of the invention, the rotor further comprises at least one pair of magnets arranged at least partly against a part of the drive shaft. In particular, the rotor comprises a pair of magnets having the shape of a portion of tube or of a parallelepiped surrounding at least part of the drive shaft, and for example a central portion of the drive shaft.

According to a variant, the motor assembly comprises a plurality of pairs of magnets housed in notches and glued to the rotor so as to respect a north pole—south pole alternation. According to this variant, the rotor comprises a lamination stack arranged between the drive shaft and the plurality of pairs of magnets. Such a rotor 13 is well known from the state of the art.

According to an embodiment of the invention, the motor assembly comprises a permanent magnet synchronous electric motor.

According to an embodiment of the invention, the drive shaft extends substantially over the entire length of the casing, the first end portion of the drive shaft being substantially located at the level of the first casing end portion, and the second drive shaft end portion being substantially located at the level of the second casing end portion.

According to an embodiment of the invention, the first guide bearing is at least partly arranged about a part of the first drive shaft end portion.

According to an embodiment, the first guide bearing is a rolling bearing, and for example a ball bearing. In this configuration, such a guide bearing is able to be subjected to an axial preload, that is to say to a preload exerted in a direction substantially parallel to the axis of rotation of the drive shaft.

According to an embodiment of the invention, the guide bearing support has the shape of a hollow cylinder and comprises an outer surface defining an outer diameter and an inner surface defining an inner diameter.

According to an embodiment of the invention, the inner diameter of the guide bearing support has at least two distinct values. According to this embodiment, the inner surface of the guide bearing support comprises at least one lateral wall of circular shape and which extends in a direction substantially parallel to the longitudinal axis of the casing when the guide bearing support and the casing are coupled, and a transverse wall of circular shape and which extends in a plane substantially orthogonal to the longitudinal axis of the casing when the guide bearing support and the casing are coupled.

According to an embodiment of the invention, the first guide bearing is at least partly disposed against a transverse wall of the inner surface of the guide bearing support.

According to an embodiment of the invention, the outer diameter of the guide bearing support is constant.

According to an embodiment of the invention, the outer diameter of the guide bearing support is very slightly less than the inner diameter presented by the casing over at least part of its length, such a configuration making it possible to couple the guide bearing support and the casing.

According to an embodiment of the invention, the guide bearing support is at least partly comprised in the casing when the guide bearing support and the casing are coupled.

According to an embodiment of the invention, the outer diameter of the guide bearing support is very slightly less than the inner diameter presented by at least part of the first end portion of the casing, which allows the guide bearing support and the casing to be coupled at the level of the first casing end portion.

According to an embodiment, one of the first and second coupling portions comprises a tapping, and the other comprises a thread configured to cooperate with the tapping.

According to an embodiment of the invention, the first casing end portion comprises a tapping made on the inner surface of the casing, and the guide bearing support comprises a thread made on at least part of the outer surface of the guide bearing support.

According to a variant, the first casing end portion comprises a thread made on the inner surface of the casing, and the guide bearing support comprises a tapping made on at least part of the outer surface of the guide bearing support.

The coupling of the guide bearing support and the casing by screwing advantageously makes it possible to exert a progressive and adjustable preload on the first guide bearing.

According to an embodiment of the invention, the thread and/or tapping are secured against loosening and/or water ingress by means of a thread lock and/or a sealing liquid.

According to an embodiment of the invention, the motor assembly comprises a blocking member configured to block the coupling of the guide bearing support and the casing.

According to an embodiment of the invention, the blocking element is configured so as to prevent a loosening of the guide bearing and the casing.

According to an embodiment of the invention, the blocking element is configured so as to prevent an unscrewing of the guide bearing support and the casing, and in particular untimely and/or unwanted unscrewing, for example when the drive shaft rotates about the drive shaft rotation axis.

According to an embodiment of the invention, the blocking element comprises a locknut configured to be coupled by screwing with the casing.

According to an embodiment of the invention, the inner diameter defined by the inner surface of the casing takes at least two distinct values at the level of the second casing end portion. According to this embodiment, the inner surface of the casing comprises, at the level of the second casing end portion, at least one lateral wall of circular shape and which extends in a direction substantially parallel to the longitudinal axis of the casing, and a transverse wall of circular shape and which extends in a plane substantially orthogonal to the longitudinal axis of the casing.

According to an embodiment of the invention, the motor assembly further comprises a second guide bearing configured to rotatably guide the drive shaft about the rotation axis of the drive shaft, and an elastic element arranged at least partly against a part of the second guide bearing, the elastic element and the casing being configured so as to exert an axial preload on the second guide bearing.

According to an embodiment of the invention, the second guide bearing is identical to the first guide bearing.

According to an embodiment of the invention, the second guide bearing is at least partly arranged about a part of the drive shaft, and in particular about a part of the second drive shaft end portion.

According to an embodiment of the invention, the elastic element is interposed between a part of the casing and a part of the second guide bearing. In particular, the elastic element is interposed between a transverse wall of the inner surface of the casing and a part of the second guide bearing. Such a configuration advantageously makes it possible to exert an axial preload directly on the second guide bearing.

According to an embodiment, the elastic element comprises an elastic washer, for example a corrugated elastic washer or a Belleville type elastic washer.

According to an embodiment of the invention, the motor assembly comprises a motor assembly configured to be controlled by an electronic control card.

According to an embodiment of the invention, the motor assembly comprises an electronic card support, and in particular an electronic control card support configured to receive an electronic control card.

According to an embodiment of the invention, the electronic card support is mounted on the casing, for example in a removable manner by means of fixing screws.

According to an embodiment of the invention, the electronic card support is mounted on one of the first and second casing end portions, and in particular on the second casing end portion.

According to an embodiment of the invention, the electronic card support comprises a substantially flat surface which extends in a plane substantially orthogonal to the longitudinal axis of the casing.

According to an embodiment of the invention, the electronic card support and the casing are made in a single piece.

According to an embodiment of the invention, the casing comprises an electronic control card housing configured to receive an electronic control card.

According to an embodiment of the invention, the second casing end portion comprises the electronic control card housing.

According to an embodiment of the invention, the electronic control card housing comprises a substantially flat receiving surface of the electronic control card which extends in a plane orthogonal to the longitudinal axis of the casing.

Such a casing integrating an electronic control card housing on the second casing end portion is permanently closed at the level of the second casing end portion. Thus, and unlike motor assemblies of the state of the art, to carry out a mounting in the casing of the different constituent elements of the motor assembly, and possibly a disassembly or a maintenance, the particular coupling of the support guide bearing and the casing is particularly advantageous, since it allows permanent access to the interior of the casing.

According to an embodiment of the invention, the motor assembly is configured to implement electrical steering assistance for a vehicle.

### BRIEF DESCRIPTION OF THE FIGURES

The invention will be better understood on reading the description made with reference to the figures. [FIG. 1], which illustrates the prior art, represents a longitudinal sectional view of an exemplary embodiment of a permanent magnet synchronous electric motor assembly known from the state of the art.

FIG. 2 represents a longitudinal sectional view of a permanent magnet synchronous electric motor assembly according to the invention.

FIG. 3 is a second longitudinal sectional view of the motor assembly of FIG. 2, shown in its immediate environment.

FIG. 4a represents a longitudinal sectional view of a permanent magnet synchronous electric motor assembly according to a first alternative embodiment of the invention.

FIG. 4b represents a longitudinal sectional view of a permanent magnet synchronous electric motor assembly according to a second alternative embodiment of the invention.

FIG. 5a to [FIG. 5c] show three perspective views of the motor assembly of FIG. 2.

FIG. 6a and [FIG. 6b] represent two perspective views of an electrically assisted vehicle steering system implementing the motor assembly of FIG. 2.

FIG. 7 represents a perspective view of a guide bearing support according to one embodiment of the invention.

FIG. 8a and [FIG. 8b] represent two perspective views of a casing according to one embodiment of the invention.

FIG. 9 represents a horizontal sectional view of a rotor according to one embodiment of the invention.

### DESCRIPTION OF A SOLUTION OF THE PRIOR ART

The electric motor assembly 100 of FIG. 1, known from the state of the art, represents a permanent magnet synchronous electric motor assembly configured to be controlled by an electronic control card (not shown).

The electric motor assembly 100 comprises a casing 101, made of aluminum alloy and forming a shell whose shape is substantially that of a hollow cylinder extending along a longitudinal axis of the casing A100 over a length of the casing. The casing 101 therefore has an inner surface of the casing, facing towards the inside of the casing 100 and defining an inner diameter of the casing, and an outer surface of the casing facing the outside of the casing 100 and defining an outer diameter of the casing.

As can be seen in FIG. 1, the casing 101 extends along the longitudinal axis A100 between a first casing end portion and a second casing end portion at which the inner diameter of the casing and the outer diameter of the casing present, each respectively, at least two distinct values. This means in particular that the inner surface of the casing has, at each of the first and second casing end portions, at least one lateral wall of circular shape which extends in a direction parallel to the longitudinal axis of the casing A100, and at least one transverse wall of circular shape which extends in a plane orthogonal to the longitudinal axis of the casing A100.

Between the first casing end portion and the second casing end portion, the casing 101 comprises a central portion having an inner diameter of substantially constant value, and an outer diameter of also substantially constant value. Thus, and in particular, the inner surface of the central portion of the casing has a lateral wall of circular shape which extends in a direction substantially parallel to the longitudinal axis of the casing.

A stator 102, fixedly mounted in the casing 101 and whose shape is also substantially that of a hollow cylinder, extends along the longitudinal axis of the casing A100 over a stator length less than the casing length and has an outer surface of the stator defining an outer diameter of the stator and an inner surface of the stator defining an inner diameter of the stator. In particular and as can be seen in FIG. 1, the stator 102 extends substantially along the central portion of the casing, and both the inner diameter of the stator and the outer diameter of the stator are of constant value over the entire length of the stator.

The value of the outer diameter of the stator is substantially equivalent to the value of the inner diameter of the casing along the central portion of the casing, and the stator 102 is fixedly mounted in the casing 101 in such a way that the outer surface of the stator is integrally arranged on a part of the inner surface of the casing, and in particular on the inner surface of the casing corresponding to the central portion of the casing.

For example, the stator 102 is fixedly mounted by hooping in the casing 101. A copper winding is wound about the stator 102 (not visible in FIG. 1).

A rotor 103, movably mounted in rotation in the casing, comprises several pairs of magnets 104 and a drive shaft 105 of cylindrical shape and extending along the longitudinal axis of the casing between a first drive shaft end portion and a second drive shaft end portion. The drive shaft 105 is able to be rotatably driven about the longitudinal axis of the casing A100. Thus, the longitudinal axis of the casing A100 corresponds to the axis of the motor assembly 100. In other words, the casing 101, the stator 102 and the rotor 103 have the same longitudinal axis A100, which is also the axis of rotation of the drive shaft 105 of the rotor 103.

As shown in FIG. 1, several pairs of magnets 104 surround the drive shaft 105 on a central portion of the drive shaft and have an outer surface, substantially circular and of constant diameter, arranged along and near the inner surface of the stator.

The length of the magnets 104 is substantially equivalent to the length of the stator. The length of the drive shaft 105 is greater than the length of the stator. The first drive shaft end portion, which extends substantially along the first casing end portion, comprises a coupling part 106, fixedly mounted on the first drive shaft end portion, for coupling a worm screw (not shown) to the drive shaft 105. The second end portion, which extends substantially along the second casing end portion, comprises a magnet position sensor 107 fixedly mounted on the second drive shaft end portion.

The casing also comprises a first ball bearing 108, arranged in particular about a part of the first drive shaft end portion, and a second ball bearing 109 identical to the first ball bearing 108, arranged in particularly about part of the second drive shaft end portion.

At the first drive shaft end portion, the drive shaft projects from the first casing end portion, to enable coupling of a worm screw to the shaft drive 105 via the coupling part 106.

At the second drive shaft end portion, the position sensor magnet 107 faces a detection cell of an electronic control card (not shown), making it possible to continuously carry out a determination of an angle of the rotor 103 relative to the stator 102. The electronic control card, which allows the control of the motor, is arranged on an electronic control card support 200, made of aluminum alloy and fixed to the second end of the casing via at least two fixing screws 301, 302 (in reality, four screws whose only two are visible in the longitudinal sectional view of FIG. 1).

The electronic control card support 200 has an inner surface facing the inside of the casing 101, and an outer surface 201, substantially flat, facing the outside of the casing 101 and extending in a plane orthogonal to the longitudinal axis of the casing A100. The outer surface 201 is particularly configured to receive the electronic control card of the electronic control card support 200 and comprises interface elements, such as screwing pads, heat dissipation surfaces or even passage openings for connection elements to the copper coils of the motor such as for example copper tabs, allowing the mounting of the electronic control card on the outer surface 201 of the electronic control card support 200.

As shown in FIG. 1, part of the electronic control card support 200 is located inside the casing 101. A circular housing 110 is intended to receive an interconnection part (not shown) which is interposed between the electronic control card support 200 and the stator 102.

The inner surface of the electronic control card support 200 comprises lateral walls of circular shape which extend in a direction parallel to the longitudinal axis of the casing A100, and transverse walls of circular shape which extend in an orthogonal plane to the longitudinal axis of the casing A100.

The second ball bearing 109, of circular shape, surrounds a part of the second drive shaft end portion by being disposed between the drive shaft 105 and the electronic control card support 200, and in particular between the drive shaft 105 on the one hand, and on the other hand both a lateral wall and a transverse wall of the inner surface of the electronic card support 200. This particular mounting of the electronic control card support 200 and of the second ball bearing 109 makes it possible to maintain the second ball bearing 109 correctly positioned in order to ensure the guiding in rotation of the drive shaft 105 during the rotation of the drive shaft 105 about the longitudinal axis A100 of the casing.

At the first casing end, the first ball bearing 108 of circular shape surrounds a part of the first drive shaft end portion by being disposed between the drive shaft 105 on the one hand, and on the other hand both a lateral wall of the inner surface of the casing and an elastic washer 111 interposed between the first ball bearing 108 and a transverse wall of the inner surface of the casing. This particular mounting of the first ball bearing 108 and of the elastic washer 111 makes it possible both to maintain the first ball bearing 108 in position during the rotation of the drive shaft 105, but also to exert an axial preload on the first ball bearing 108 in order to fill any assembly clearances and to compensate for any thermal expansions generated by the operation of the motor, and in particular by the friction caused by the high speed rotation of the drive shaft 105, by the magnetic losses in the form of heat, as well as by the temperature variations in the environment under the motor cowl of a motor vehicle which may generally range from −40° C. to 140° C.

The motor assembly 100 previously described has various drawbacks, and in particular that relating to the direct dependence on the assembly tolerances of the axial preload exerted through the elastic washer 111. In addition, the presence of the elastic washer 111 significantly increases the overall length of the motor assembly 100, which proves problematic in many environments where such a motor assembly is used.

Finally, the electronic control card support 200, and in particular its fastening to the second casing end portion, complicates the overall architecture and the mounting of the motor. The fastening screws 301, 302 of the electronic control card support 200 on the casing 101 occupy a certain volume reducing the space available for the interface elements of the electronic control card. Additionally, the fastening screws 301, 302 also increase the length of the motor assembly 100 and may further unscrew during the operation of the motor. Such unscrewing would make the electronic control card support 200 unstable, which would have a detrimental influence both on the stability of the positioning of the first and second ball bearings 108, 109, and in particular of the second ball bearing 109, but also on the operation of the motor in general since a poor stability of the electronic control card support 200 would necessarily lead to disturbances in the determination of the angle formed by the rotor 103 relative to the stator 102.

### DETAILED DESCRIPTION

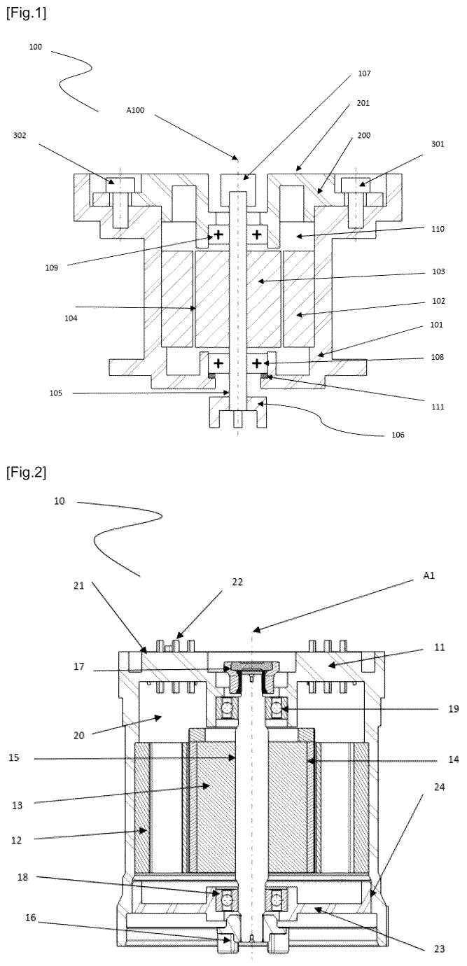

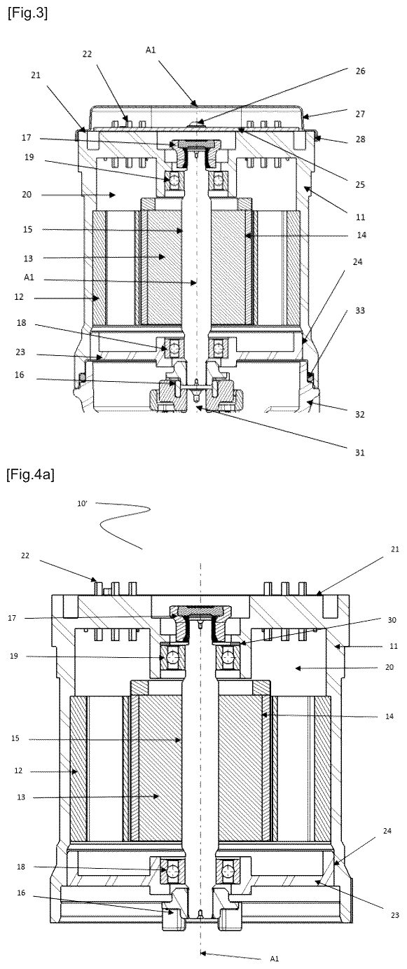

The motor assembly 10 of FIG. 2, according to one embodiment of the invention, represents a permanent magnet synchronous electric motor assembly configured to be controlled by an electronic card 25 (represented in FIG. 3).

The motor assembly 10 comprises a casing 11, made of aluminum alloy and forming a shell having substantially the shape of a hollow cylinder which extends along a longitudinal axis A1 of the casing over a length of the casing. The casing 11 therefore has in particular an inner surface of the casing, facing towards the inside of the casing and defining an inner diameter of the casing, and an outer surface of the casing facing outwards and defining an outer diameter of the casing.

As can be seen in FIG. 2, the casing 11 extends along the longitudinal axis A1 of the casing between a first casing end portion and a second casing end portion at which the value of the inner diameter of the casing takes several distinct values. This means in particular that the inner surface of the casing has, at the second casing end portion, at least one lateral wall of circular shape which extends in a direction parallel to the longitudinal axis A1 of the casing, and at least one transverse wall of circular shape which extends in a plane orthogonal to the longitudinal axis A1 of the casing.

Between the first casing end portion and the second casing end portion, the casing 11 comprises a central portion having an inner diameter of substantially constant value and an outer diameter of also constant value. Thus and in particular, the inner surface of the central portion of the casing has a single lateral wall of circular shape which extends in a direction parallel to the longitudinal axis A1 of the casing.

A stator 12 fixedly mounted in the casing and whose shape is that of a hollow cylinder, extends in a direction parallel to the longitudinal axis A1 of the casing over a stator length less than the casing length and has an outer stator surface and an inner stator surface. In particular and as can be seen in FIG. 2, the stator 12 extends substantially along the central portion of the casing, and has an inner stator diameter of constant value and an outer stator diameter of constant value over the entire length of the stator 12.

The value of the outer diameter of the stator is substantially equivalent to the value of the inner diameter of the casing which the casing 11 presents at the central portion of the casing, and the stator 12 is fixedly mounted in the casing 11 in such a way that the outer surface of the stator is entirely disposed on a part of the inner surface of the casing, and in particular on the inner surface of the casing corresponding to the central portion of the casing. A copper winding (not visible in the figures) is wound around the stator 12.

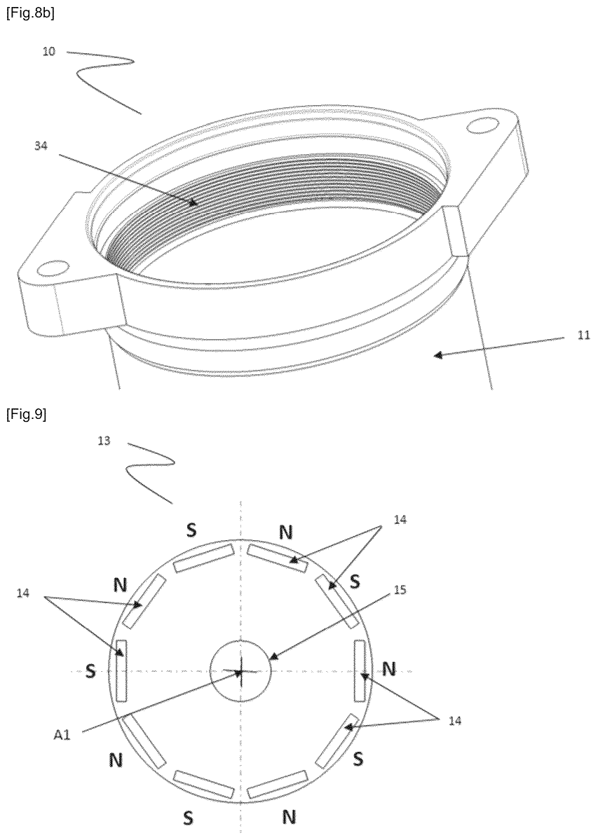

A rotor 13, movably mounted in rotation in the casing 11, comprises several pairs of magnets 14 and a drive shaft 15 of cylindrical shape and extending along the longitudinal axis A1 of the casing between a first drive shaft end portion and a second drive shaft end portion. As represented in FIG. 9, the magnets of the plurality of pairs of magnets 14 are housed in notches and glued to the rotor 13 so as to respect a north pole—south pole alternation. A plurality of sheets (not visible in FIG. 9) stacked on top of each other are disposed between the drive shaft 15 and the plurality of pairs of magnets 14.

The drive shaft 15 is capable of being rotated about the longitudinal axis A1 of the casing. Thus, the longitudinal axis A1 of the casing corresponds to the axis of the motor assembly 10. In other words, the casing 11, the stator 12 and the rotor 13 have the same longitudinal axis A1, which is also the axis of rotation of the drive shaft 15 of the rotor 13.

As can be seen in FIG. 1 and FIG. 9, the pairs of magnets 14 have, in a known manner, the shape of a portion of a tube or a parallelepiped and have an inner surface, of substantially circular shape and of constant diameter, surrounding the drive shaft on a drive shaft central portion, and an outer surface, substantially circular and of constant diameter, disposed along and close to the inner surface of the stator.

The length of each of the magnets 14 is substantially equivalent to the length of the stator. The length of the drive shaft 15 is greater than the length of the stator. The first drive shaft end portion, which extends substantially along the first casing end portion, comprises a coupling part 16, fixedly mounted on the first coupling shaft end portion, for coupling a worm screw (not represented in FIG. 2) to the drive shaft 15. The second drive shaft end portion, which extends substantially along a part of the second casing end portion, comprises a position sensor magnet 17 fixedly mounted on the second drive shaft end portion.

The casing also comprises a first guide bearing 18, disposed in particular around a part of the first drive shaft end portion, and a second guide bearing 19 identical to the first guide bearing 18, disposed in particularly around a part of the second drive shaft end portion.

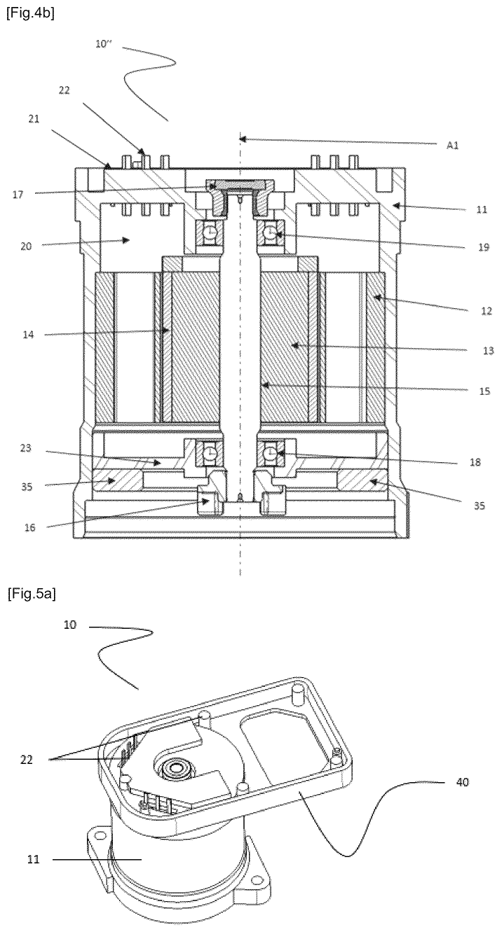

In the embodiment described in FIGS. 2 and 3, as well as in the first variant represented in FIG. 4a and in the second variant represented in FIG. 4b, the guide bearing 18 comprises a ball bearing. Likewise, the guide bearing 19, identical to the guide bearing 18, also comprises a ball bearing. According to one variant, it is specified that, according to a variant not represented in the figures, the guide bearing 19 may be structurally different from the guide bearing 18.

The position sensor magnet 17 faces a detection cell (not represented) placed on the electronic control card 25 (visible in particular in FIG. 3), making it possible to continuously determine an angle formed by the rotor 13 relative to the stator 12.

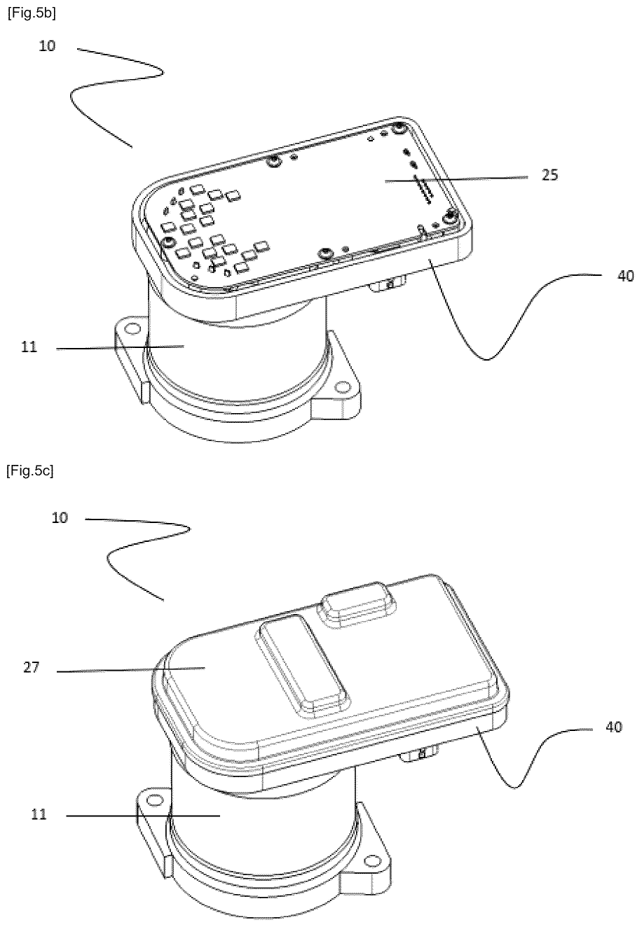

At the second casing end portion, the casing 11 has an electronic control card housing 40 (visible in FIG. 5a) which notably comprises an electronic control card receiving surface 21 which is substantially flat and which is extends in a plane orthogonal to the longitudinal axis A1 of the casing so as to receive the electronic control card 25.

Unlike the motor assembly 100, the motor assembly 10 according to the invention has the particularity of allowing the positioning of the electronic control card 25 directly on the casing 11. In other words, the casing 11 serves to both as a protective shell for some of the constituent elements of the motor, in particular the stator and the rotor, but also as electronic control card housing, all in one piece.

The electronic control card receiving surface 21 comprises interface elements 22, such as screwing pads, heat dissipation surfaces and openings of passage for elements of connection to the copper coils of the motor such as for example copper tabs, allowing the mounting of the electronic card on the electronic control card receiving surface 21. To protect the electronic control card 25, a cowl 27 mounted, in a removable or not removable manner, on the casing 11, visible in FIG. 5c, makes it possible to completely cover the electronic control card housing 40, and therefore the electronic control card receiving surface 21.

A circular housing 20 is intended to receive an interconnection part (not represented in the figures) which is interposed between the interface elements 22 and the stator 12. According to one variant, the housing 20 is only partially circular.

The second guide bearing 19, of circular shape, surrounds a part of the second drive shaft end portion while being disposed between said part of the second drive shaft end portion and the casing 11, and in particular between said part of the second drive shaft end portion 15 on the one hand, and on the other hand both a lateral wall and a transverse wall of the inner surface of the casing, in particular of the inner surface of the casing located at the second casing end portion. This particular mounting of the second guide bearing 19 makes it possible to maintain the second guide bearing 19 correctly positioned in order to allow an effective rotational guide of the drive shaft 15 during the rotation of the drive shaft 15 about the longitudinal axis A1 of the casing.

The first guide bearing 18 of circular shape surrounds a part of the first drive shaft end portion by being disposed between said part of the first drive shaft end portion and a guide bearing support 23 configured to couple with the casing 11.

The guide bearing support 23, which has substantially the shape of a hollow cylinder, extends, when coupled with the casing 11, along the longitudinal axis A1 over a length of the guide bearing support. The guide bearing support 23 comprises an outer surface of the guide bearing support and an inner surface of the guide bearing support.

The inner surface of the guide bearing support has a diameter which takes several distinct values. The inner surface of the guide bearing support therefore comprises both lateral walls of circular shape which extend in a direction substantially parallel to the longitudinal axis of the casing A1, and transverse walls of circular shape which extend in a plane substantially orthogonal to the longitudinal axis A1 of the casing. The outer surface of the guide bearing support has a constant outer diameter.

As represented in FIG. 2, the first guide bearing 18 is disposed against both a lateral wall and a transverse wall of the inner surface of the guide bearing support.

To enable coupling between the guide bearing support 23 and the casing 11, the casing, and in particular the first casing end portion, comprises a first coupling part, and the guide bearing support 23 comprises a second coupling part configured to cooperate with the first coupling part.

In particular and as shown in FIGS. 8a and 8b, a part of the inner surface of the casing 11, located at the first casing end portion and having a constant inner diameter slightly greater than the outer diameter of the bearing support guide, comprises a tapping 34.

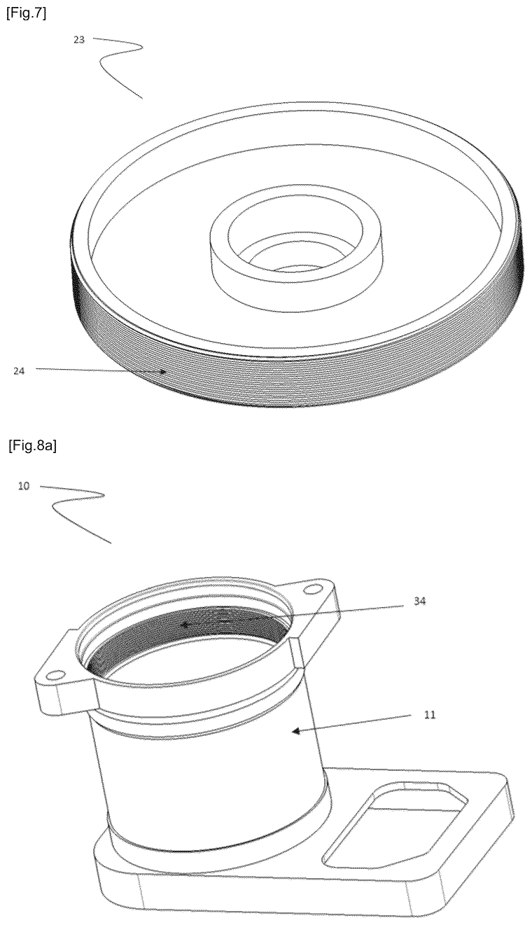

The outer surface of the guide bearing support 23 comprises a thread 24, as represented in FIG. 7.

The thread 24 presented by the outer surface of the guide bearing support 23 is able to cooperate with the tapping 34 made on said part of the inner surface of the casing 11. In other words, the guide bearing support 23 is able to be screwed into the casing 11, at the first casing end portion. Such screwing has the effect of progressively advancing the guide bearing support 23, during its mounting in the casing 11, in a direction substantially parallel to the longitudinal axis A1 of the casing and in a direction going from the first casing end portion to the second casing end portion.

This particularly advantageous mounting of the first guide bearing 18 and of the guide bearing support 23 in the casing 11 makes it possible to maintain the first guide bearing 18 in a stable position during the rotation of the drive shaft 15 in order to allow a satisfactory guidance of the drive shaft 15, but also to apply an adjustable and progressive axial preload on the first guide bearing 18 in order to effectively fill any assembly clearances and compensate for any thermal expansions generated by the operation of the motor, and in particular by the friction caused by the high speed rotation of the drive shaft 15, by the magnetic losses in the form of heat, as well as by the temperature variations in the environment under the motor cowl of a motor vehicle which may generally range from −40° C. to 140° C.

Compared to the axial preload provided by the elastic washer of the motor assembly 100 of FIG. 1, the particular coupling of the guide bearing support 23 and of the casing 11 makes it possible to apply an adjustable and progressive preload, i.e. that is to say that the value of the axial preload depends directly on the tightening torque generated by the screwing of the guide bearing support 23 in the casing 11. Such an adjustable preload does not depend on the assembly tolerances and may be refined adequately. Furthermore, the absence of elastic washer in the motor assembly 10 makes it possible to reduce the length of the motor assembly 10. In addition, the fact that the casing 11 also acts as an electronic card support, in other words, the fact that the electronic card support and the casing 11 are made in a single piece, makes it possible to dispense with the fastening screws 301, 302 present in the motor assembly 100 of FIG. 1. The absence of such fastening screws 301, 302 ensure a significant saving of space and further reduce the length of the motor assembly 10.

Finally and unlike the motor assembly 100, the motor assembly 10 mounts and dismounts by the first casing end portion, since the screw coupling of the guide bearing support 23 and of the casing 11 allows at any time a removal of the guide bearing support 23, thus allowing access to the interior of the casing 11.

The motor assembly 10 is represented in FIG. 3 in its immediate environment.

One end 31 of a worm reducer worm screw is fixedly mounted on the coupling part 16, in order to couple the worm reducer worm screw to the drive shaft 15, this which allows the drive shaft 15 to rotate the worm reducer worm screw about the longitudinal axis A1 of the casing.

The worm reducer casing 32 is coupled to the casing 11 by being fitted into the casing 11 at the first casing end portion. An O-ring 33, suitably interposed between the casing 11 and the worm reducer casing 32, ensures the sealing of the coupling.

At the second casing end portion, the electronic control card 25 (also visible in FIG. 5b) is disposed on the electronic control card receiving surface 21. As described above, the electronic control card receiving surface 21 extends in a plane substantially orthogonal to the longitudinal axis A1 of the casing and has interface elements 22 (also visible in FIG. 5a) such as screw pads, heat dissipation surfaces and openings of passage for elements of connection to the copper coils of the motor such as for example copper tabs, which make it possible to interface the electronic control card 25 and the electronic control card receiving surface 21. At least one fastening screw 26 (in reality several fastening screws, as represented in FIG. 5b) makes it possible to fasten the electronic control card 25 on the electronic control card receiving surface 21.

The cowl 27 is mounted, in a removable or not removable manner, on the casing 11 so as to protect the electronic control card 25 by completely covering the electronic control card housing 40 (as is also visible in Figure Sc). Finally, a sealing element 28 is interposed between the cowl 27 and the casing 11 in order to ensure the sealing of the coupling between the casing 11 and the cowl 27.

In FIG. 4a is represented a motor assembly 10′ according to a first variant of the invention. Compared to the motor assembly 10 represented in FIG. 2, an elastic element 30 is interposed between the second guide bearing 19 and a transverse wall of the inner surface of the casing, in particular the transverse wall against which the second guide bearing 19 is disposed in the motor assembly 10 represented in FIG. 2. The elastic element 30 makes it possible to exert an axial preload directly on the second guide bearing 19, so as to compensate for the thermal expansions and to fill the assembly clearances present in particular at the second casing end portion. Compared to the motor assembly 10 of FIG. 2, the motor assembly 10′, although having the disadvantage of being longer than the motor assembly 10, has the advantage of allowing a finer adjustment of the axial preload of the first and second guide bearings 18, 19 through both the guide bearing support 23 and the elastic element 30, thus authorizing the application of a direct axial preload both on the first guide bearing 18 and on the second guide bearing 19.

In FIG. 4b is represented a motor assembly 10″ according to a second variant of the invention. Compared to the motor assembly 10 represented in FIG. 2, the motor assembly 10″ has a counter nut 35 screwed into the tapping 34 of the casing 11 and tightened against the guide bearing support 23. Thus, the counter nut 35, coupled by screwing with the casing 11, is configured to block the coupling of the guide bearing support 23 and of the casing 11 and thus prevent a loosening of the guide bearing support 23 and of the casing 11. Advantageously, the counter nut 35 is configured so as to prevent an unscrewing of the guide bearing support 23 and of the casing 11, and in particular an untimely and/or unwanted unscrewing, for example when the drive shaft 15 rotates about the axis of rotation of the drive shaft.

According to an alternative or complementary embodiment not represented in the figures, the thread 24 and/or the tapping 34 are secured against a loosening and/or water ingress by means of a thread lock and/or a sealing liquid.

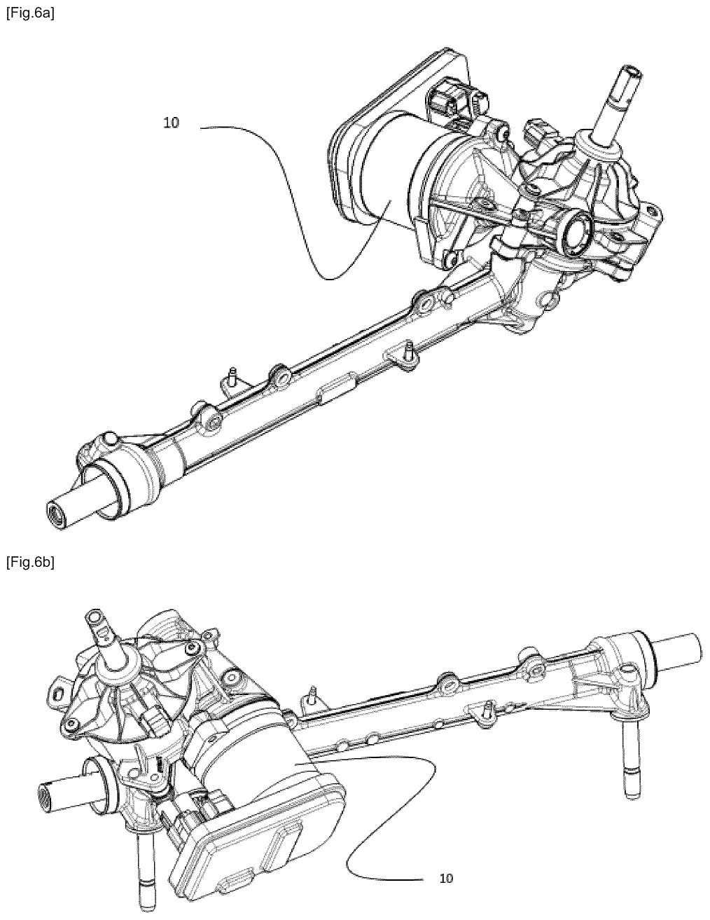

The motor assembly 10 is advantageously used in environments where available space is limited. For example, the motor assembly 10 may be used in an automotive environment, to provide electrical assistance to vehicle steering, as represented in FIGS. 6a and 6b.

Of course, the present invention is in no way limited to the embodiment described and illustrated which has been given only by way of example. Modifications remain possible, particularly from the point of view of the constitution of the various elements or by substitution of technical equivalents, without departing from the scope of protection of the invention.

1. A motor assembly comprising:
a casing extending at least partly along a longitudinal axis of the casing between a first casing end portion and a second casing end portion;
a stator fixedly mounted in the casing;
a rotor movably mounted in rotation in the casing, the rotor comprising a drive shaft which has a first drive shaft end portion extending along the first casing end portion and on which a coupling part is mounted, and a second drive shaft end portion extending along the second casing end portion, the drive shaft being configured to be guided in rotation about an axis of rotation of the drive shaft;
a first guide bearing configured to guide in rotation the drive shaft about the axis of rotation of the drive shaft;
the motor assembly being characterized in that it further comprises a guide bearing support configured to couple with the casing at the first casing end portion and to support the first guide bearing, the guide bearing support and the casing being further configured such that a coupling of the guide bearing support and of the casing makes it possible to exert an adjustable axial preload on the first guide bearing.

2. The motor assembly according to claim 1, wherein the casing comprises a first coupling part, and the guide bearing support comprises a second coupling part adapted to cooperate with the first coupling part.

3. The motor assembly according to claim 2, wherein the first casing end portion comprises the first coupling part.

4. The motor assembly according to claim 2, wherein one of the first and second coupling parts comprises a tapping 34, and the other comprises a thread 24 configured to cooperate with the tapping 34.

5. The motor assembly according to claim 1, which comprises a blocking element configured to block the coupling of the guide bearing support and of the casing.

6. The motor assembly according to claim 1, which further comprises a second guide bearing configured to guide in rotation the drive shaft about the axis of rotation of the drive shaft, and an elastic element disposed at least partly against a part of the second guide bearing, the elastic element and the casing being configured so as to exert an axial preload on the second guide bearing.

7. The motor assembly according to claim 1, wherein the casing comprises an electronic control card housing configured to receive an electronic control card.

8. The motor assembly according to claim 7, wherein the second casing end portion comprises the electronic control card housing.

9. The motor assembly according to claim 7, wherein the electronic control card housing comprises an electronic control card receiving surface which is substantially planar and which extends in a plane orthogonal to the longitudinal axis of the casing.

10. The motor assembly according to claim 1, configured to implement electrical steering assistance for a vehicle.
